(19) United States
(12) Patent Application Publication
(10) Pub. No.: US 2009/0177312 A1
(43) Pub. Date: Jul. 9, 2009

(54) POSTAGE METER SYSTEM WITH INTEGRATED IMAGE SENSOR

(75) Inventor: David AUDEON, Massy (FR)

Correspondence Address: SUGHRUE MION, PLLC, 2100 PENNSYLVANIA AVENUE, N.W., SUITE 800, WASHINGTON, DC, 20037, US

(73) Assignee: NEOPOST TECHNOLOGIES, Bagneux (FR)

(21) Appl. No.: 12/348,172

(22) Filed: Jan. 2, 2009

(30) Foreign Application Priority Data
Jan. 4, 2008 (FR) 0850043

(51) Int. Cl. G06F 17/00

(52) U.S. Cl. 700/213

(57) ABSTRACT

A digitization device (26) for a postage meter system for postal articles comprising a contact image sensor (CIS 20A), a support on which this sensor is fixed, the support being arranged in a direction perpendicular to the advance of postal articles (10) in the postage meter system and having a longitudinal axis and a transverse axis, and at least one movable fixing means (44A, 44B) for fixing the support onto a part of the structure of the postage meter system so as to allow a vertical movement of the support and its swiveling both about the longitudinal axis and about the transverse axis.

### TECHNICAL FIELD

The present invention relates exclusively to the field of processing post and it more particularly concerns a postage meter system of which one of the constituent modules, such as the module for feeding postal articles (feeder), the module for weighing postal articles (postal scales), the module for printing these postal articles (postage meter in the strict sense), the module for folding and inserting (folder/inserter) or any other independent module, comprises an integrated image sensor.

### PRIOR ART

It is well known that postal administrations or private carriers use complex digitization systems enabling many checking and tracking applications, in particular the analysis of postal articles and their sorting according to their destination. These systems are, however, particularly expensive and their volume is large due in particular to the use of cameras. They are therefore only really of interest to a sender if this sender processes large volumes of post, such as a router. Indeed, in the context of a standard postage meter system in the post-dispatch room of a company and formed for example of a feeder, postal scales, a postage meter and optionally a folder/inserter, the digitization of postal articles using similar technologies is not conceivable.

For these conventional postage meters it is necessary to make use of small-sized sensors, of the CIS (Contact Image Sensor) type, today used above all in the digitization units of photocopiers. However, in these photocopiers, as the thickness of the paper is relatively constant, low and uniform, the sensor known as a CIS is generally stationary.

It is completely different with a postage meter system. This is because the upper face of postal articles is not always planar, variations in thickness due to the content of the article or misshapen articles due to being transported through the system may alter the quality of the digitization. In addition, the digitized area is relatively large, typically greater than 30 cm. This is because, depending on the format of the postal article, the position of the destination address is different and it is desirable to be able to digitize not only this destination address but also the other information visible on the postal article (amount of postage paid, address of the sender, etc.).

A first solution to these problems is given by the digitization device specially adapted to postage meter systems and illustrated in patent application FR 07 57285 filed in the name of the applicant. In this movable and no longer stationary device, the transporting of postal articles takes place while keeping a common reference which is the lower face of these postal articles. Thus, whatever the thickness of the postal article, its lower face will therefore always pass at the same place in the system.

This device yields overall satisfaction, especially for low or medium postage metering rates. Conversely, for high rates it suffers from certain drawbacks owing mainly to the amplitude of sensor movement, which may then be a few tens of mm. Indeed, this sensor has to move vertically by a value equal to the thickness of the postal article (which may vary from 0.2 mm to more than 20 mm). Yet, if the rates of postage metering and hence of digitization are high—they may be as much as 5 articles per second—rapid vertical movement of the sensor causes vibrations which, apart from the fact that they are unfavorable for good digitization quality, may damage it. In addition, at high speed, during the passage of a postal article of significant thickness (more than 15 mm) followed by one of lesser thickness (a few mm), the sensor does not have time to return to its rest position in order to digitize the second postal article.

### OBJECT AND DEFINITION OF THE INVENTION

The object of the present invention is therefore to eliminate the aforementioned drawbacks by installing a sensor, called a CIS, in a postage meter system that enables correct digitization of the entire surface of postal articles, whatever the format (from business card format through to the largest format) and the thickness of this postal article. One aim of the invention is to allow this sensor to adapt itself to the movements and to misshapen surfaces of the postal article, while enabling a digitization of sufficient quality to be able to use character recognition software analyzing the digitized images. Another aim of the invention is to control the distance between the sensor and the postal article as a guarantee of good digitization quality. Another aim of the invention is also to propose a feeder device that does not require a redefinition of its general architecture.

These aims are achieved by a digitization device for a postage meter system for postal articles, comprising:
a contact image sensor (CIS),
a support on which said sensor is fixed, said support being arranged in a direction perpendicular to the advance of postal articles in said postage meter system and having a longitudinal axis Y and a transverse axis X, and
a movable fixing means for fixing said support onto a part of the structure of said postage meter system so as to allow a vertical movement of said support (translation along the Z axis) and its swiveling both about said longitudinal axis (rotation about the Y axis) and about said transverse axis (rotation about the X axis).

Thus, through this simple structure the sensor is able to move both vertically and rotationally about its longitudinal and transverse axes, which enables it to adapt to all thicknesses of postal article and to digitize automatically postal articles during their movement.

According to a preferred embodiment, said movable fixing means comprises two suspension arms hinge-joined at one end to a common axle joined to said part of the structure and at another end to a swivel pin fixed to said support, said swiveling about said transverse axis being ensured by a play in the connection of said first end.

According to another embodiment, said movable fixing means comprises a suspension arm hinge-joined at one end to a common axle joined to said part of the structure and at another end to a ball joint joined to said support so as to enable, by means of said ball joint, said swiveling both about said transverse axis and about said longitudinal axis, stops furthermore being provided in order to avoid any rotation during said vertical movement of said support.

Preferably, it furthermore comprises a damping device in order to damp said vertical movement of said support. Said damping device may consist of a simple spring.

Said contact image sensor is formed of an integrated module comprising adjacent detection cells made of semiconductor, collimation optics and an illumination system.

Depending on the available space, the digitization device may be mounted in an independent subassembly of the postage meter system or in one of the following subassemblies of the postage meter system: feeder, postal scales, postage meter, folder/inserter.

The invention also relates to any element of a postage meter system comprising such a digitization device and in which said postal articles are applied to said digitization device by a presser unit positioned to the right of said digitization system. Said presser unit is preferably mounted on springs or any other similar system enabling the application of a compressive force to the postal article.

### BRIEF DESCRIPTION OF THE DRAWINGS

The invention will be understood better in view of the following detailed description, accompanied by illustrative and nonlimiting examples with regard to the following figures, in which:

FIG. 1 is a general view of a postage meter system to which the invention is applied,

FIG. 2 is a cutaway view of a first embodiment of the invention,

FIG. 3 is a perspective view of the sensor assembly employed in FIG. 2,

FIG. 4 illustrates the movement of the sensor assembly with a postal article of variable thickness,

FIGS. 5A to 5C illustrate in cross section three successive positions of a postal article in front of the sensor assembly of FIG. 3,

FIG. 6 is a cutaway view of a second embodiment of the invention, and

FIG. 7 is a perspective view of the sensor assembly employed in FIG. 6.

### DETAILED DESCRIPTION OF EMBODIMENTS

The invention is based on the use of a system described as a high reference system, in which the upper face of the postal article, i.e. the face that it is desired to digitize, is always situated in the same position, whatever the thickness of this postal article and therefore always passes at the same place in the system.

In such a system, the sensor, called a CIS, is fixed on a movable support which follows the deformations and movements of the upper face of the postal article. The sensor is thus not located in a fixed position because, as the transporting of postal articles in the machine is not perfect, the upper face of these postal articles is not always strictly planar. It is therefore necessary to allow the sensor to move and to swivel while keeping a small fixed distance between the sensor and the upper face of the postal article that it is desired to digitize, as the depth of field of such a sensor is limited.

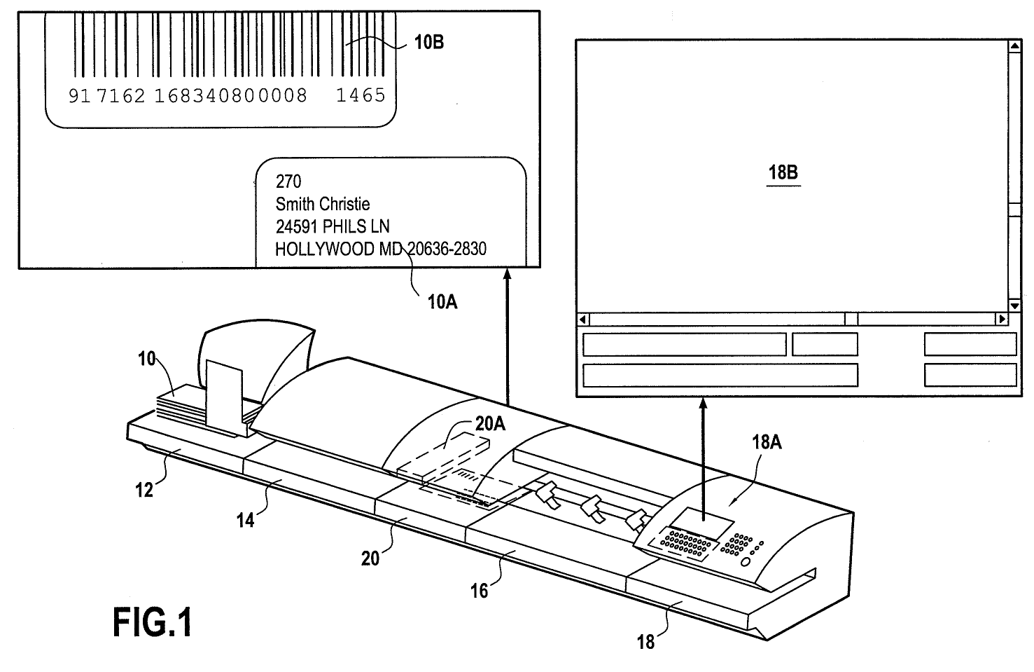

FIG. 1 illustrates a postage meter system for postal articles comprising, as is known and arranged from upstream to downstream in the direction of advance of the postal articles 10: a feeder module 12 for feeding postal articles intended to receive a pile of postal articles, typically unsorted (i.e. of varying sizes and weights) each comprising a destination address 10A and, in the example illustrated, an identifier 10B relating to a value-added postal service; optionally, a module 14 for selection and transport of these postal articles one by one when the feeder module does not directly carry out this individual selection; preferably, a module 16 for dynamically weighing postal articles and optionally determining the size of each selected postal article and a printing module 18 intended to print a postmark on each of the postal articles thus selected one by one and weighed. The printing module is preferably, as is also known, connected to a server (not shown) of an agent of this postage meter system, which is itself connected to a server of a postal administration or of a private carrier ensuring the distribution of the post (not shown).

In the embodiment illustrated, the postage meter system furthermore comprises an independent optical reader module 20 comprising a sensor 20A, advantageously linear, of the so-called “contact” type, positioned upstream of the dynamic weighing module (though a different arrangement is also conceivable), in order to acquire a digital image of the postal article 10 and to extract from this at least the identifier 10B relating to the value-added service desired for this postal article and the destination address 10A carried on the postal article. To do this, this image sensor is associated with barcode recognition and optical character recognition (OCR) software. The printing module furthermore comprises an improved user interface 18A with a keyboard enabling the display on a screen 18B of all or part of the image of the postal article thus digitized and, if necessary, correction of the postal data extracted from this image. The keyboard may be a physical keyboard interacting with a virtual keyboard on the screen 18B, which is then advantageously of the touch type, or purely and simply be replaced by this touchscreen. The printing module may also comprise storage means (not shown) of the database type in order to store the image of the envelope thus digitized.

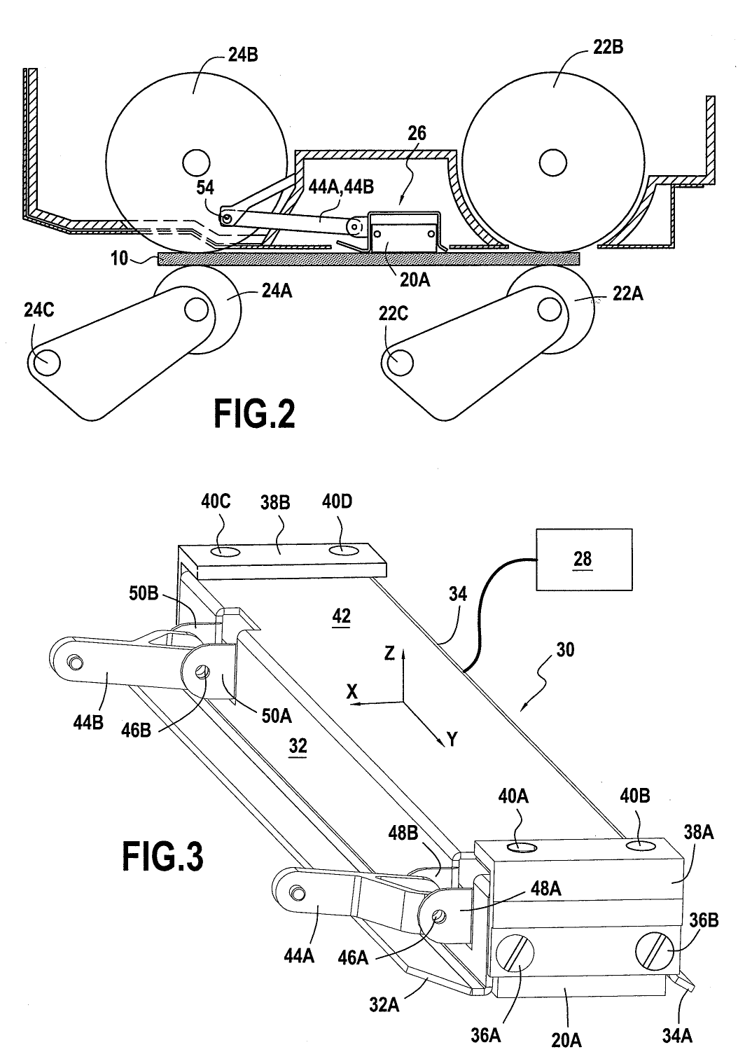

FIG. 2 shows, in a first embodiment, a detail of the optical reader module 20 and in particular of the transport rollers formed, for example, of two adjacent assemblies of superposed front 22A, 22B and rear 24A, 24B transport rollers for transporting the postal articles through the module. The lower rollers 22A, 24A of these two assemblies are mounted loosely and in a vertically mobile manner about rotation axes 22C, 24C in order to adapt to various thicknesses of postal articles and the upper rollers 22B, 24B are motorized and synchronously actuated by various known control and monitoring means required for their operation and which it is therefore unnecessary to describe in greater detail.

According to the invention, in order to enable automatic processing of postal articles and not to increase the size of the module, it is proposed to put a movable optical reader assembly 26 between these two series of transport rollers, said assembly comprising the sensor 20A and enabling, in connection with a processing means 28, digitization and automatic recognition of the information carried by these postal articles. This assembly will be movable to follow the upper surface of the postal article, which is not uniform, and therefore ensure through its movement and its privileged position in the system an optimum digitization quality, whatever the thickness of the postal articles, in particular in the presence of thick envelopes. The triggering of digitization and the processing of data by the processing means 28 may advantageously be synchronized using a detector (not shown) of the front of each of the postal articles. This digitization may also be carried out continuously, the synchronization then being carried out by detecting change in the gray level or change in the color appearing systematically when passing from one envelope to another.

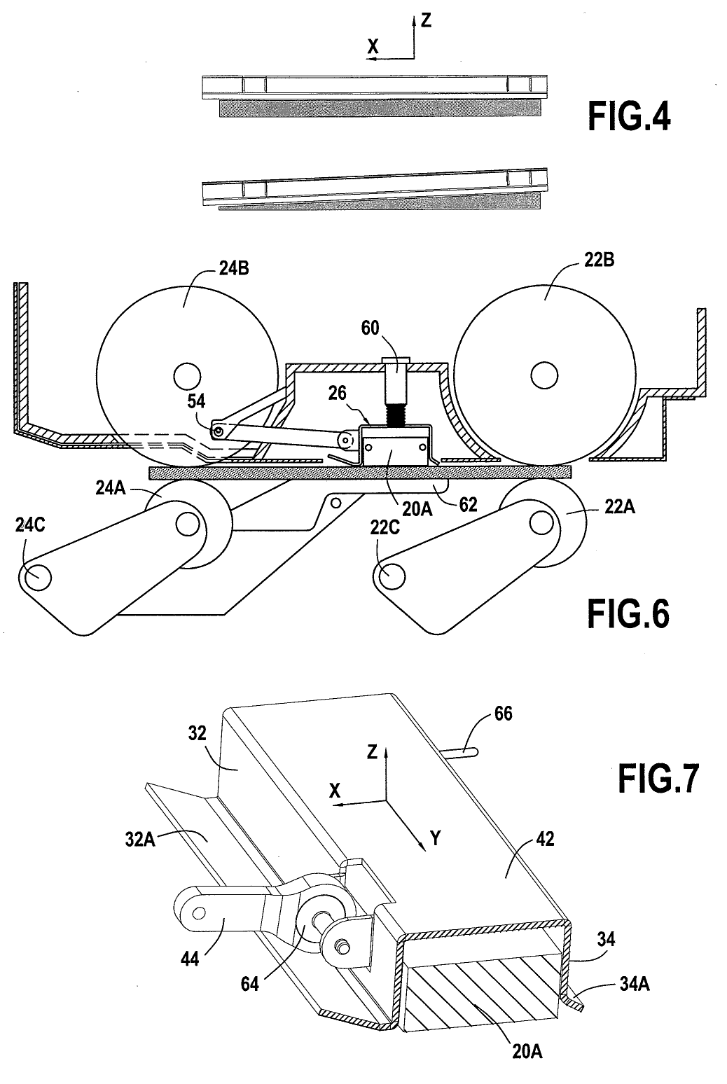

The perspective of FIG. 3 shows more precisely the movable optical reader assembly 26 comprising the sensor 20A mounted in a support 30 in the form of a bridge having a longitudinal axis (Y axis) and a transverse axis (X axis) and comprising an upstream deflector 32A and a downstream deflector 34 at the base of its two longitudinal walls 32, 34 respectively. The sensor is fixed to the support, for example, by two screws 36A, 36B each passing through two end plates 38A, 38B which are themselves fixed by screws 40A, 40B, 40C, 40D to the upper wall 42 of the support 30. The lower surface of the sensor is kept in alignment with the deflectors in order to ensure planar contact with the upper surface of the postal articles. However, a movement back along the Z axis of 0.5 mm at most is tolerated for a sensor whose depth of field does not exceed 2 mm. The upstream deflector comprises an inclined leading edge 32A to allow the postal article to press gradually on the support, and the downstream deflector comprises a heel 34A which allows a desired distance between the postal article and the sensor to be maintained. In the example illustrated, the sensor/deflectors assembly is supported by two suspension arms 44A, 44B, each hinged at a first end on an individual swivel pin 46A, 46B mounted between two lugs 48A, 48B; 50A, 50B extending from the upstream longitudinal wall 32 of the support to a second end on a common hinge pin 54 joined to the frame of the module. These two arms allow the movable support and the sensor it surrounds to be longitudinally and transversely locked, i.e. to prevent any translation along the X and Y axes or rotation about the Z axis by them, the assembly then being able to move freely in translation only in the vertical Z direction and in rotation about the X and Y axes, the independence of the two arms, which are mounted with play, enabling the sensor to swivel freely about its transverse axis (rotation about the X axis). Thus the sensor is able to adapt to the shape of the postal article (and in particular a variable thickness along its width) as the two positions in FIG. 4 show, one having undergone a rotation about the X axis of around 10° relative to the other, which is particularly advantageous when a document of large width is to be digitized.

Of course, the movable support may be connected to the frame of the module by any other mechanical connection than the two previously described suspension arms provided that a degree of freedom for vertical movement is allowed. Thus, a device simply comprising two springs (or two damping devices) suspended from the frame and retaining the upper wall of the support are also perfectly suitable.

The sensor is advantageously a contact image sensor, linear in type, the length of which is designed for digitizing at least one width of a postal article covering the postmark and the destination address, whatever the format of this postal article. This linear image sensor is typically an integrated module comprising adjacent CCD or CMOS detection cells made of semiconductor, collimation optics and an illumination system which, when it is activated, illuminates the surface over which the sensor is positioned and delivers in return, at each of the detection cells, a signal proportional to the light reflected by the surface of the postal article.

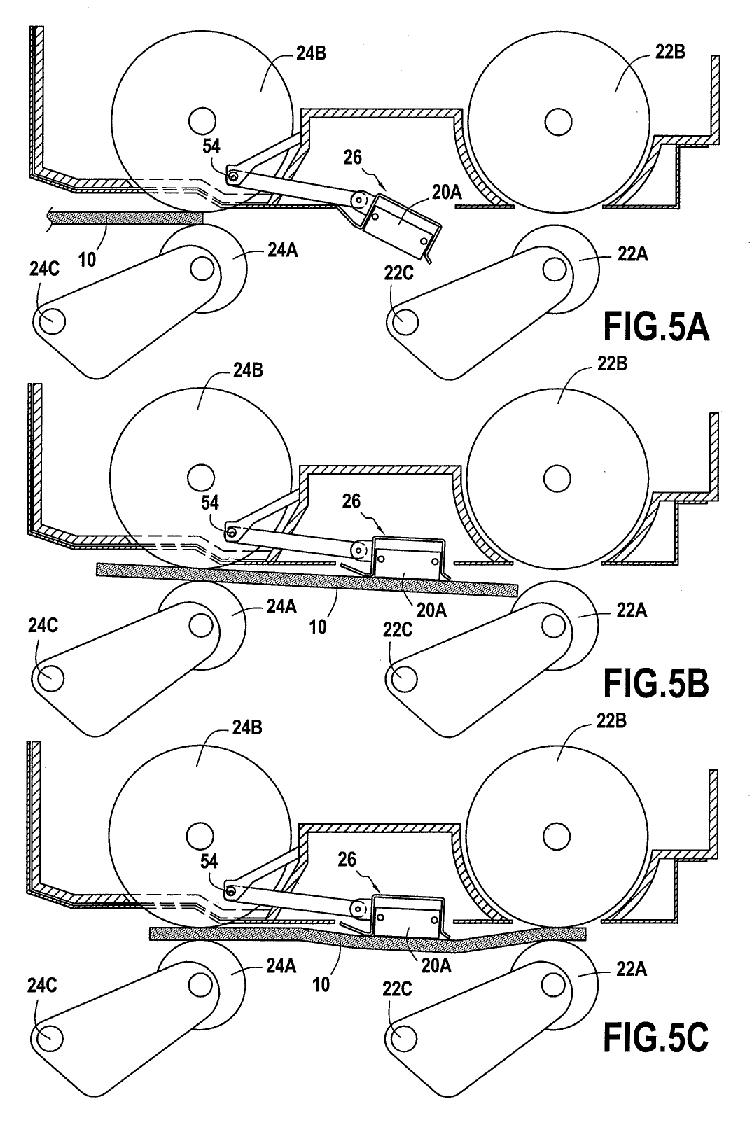

The operation of the feeder device will now be described with regard to FIGS. 5A to 5C, which show the movable optical reader assembly in three positions of successive advance of a postal article (the visual effects are deliberately exaggerated to facilitate their understanding). In FIG. 5A, the movable optical reader assembly 26 is at rest, the sensor then crossing the transport path of the postal articles (note that this crossing may be advantageously limited by the addition of a stop). In FIG. 5B the postal article has advanced on this transport path, has come into contact with the leading edge of the upstream deflector, which it has lifted slightly to assume the illustrated position. In FIG. 5C the postal article has again moved downstream and has come to engage with the front transport rollers 22A, 22B. During the entire movement of the postal article, the sensor 20A has remained constantly in contact with it, which has allowed it to proceed, line by line, to acquire an image of the surface of the postal article. This acquisition is carried out from a start signal delivered by the detector of the front of the postal article or by automatic recognition by and under the control of the processing means 28.

The signals gathered by this processing means may be analog or digital depending on the nature of the sensor and will therefore, if necessary, be digitized and normalized at a programmable circuit (for example, an FPGA) before being stored in a RAM data memory of the module in which the image of the postal article will be reconstituted. Digital processing of this image in a microprocessor of the module will then, depending on the application employed and available in a ROM program memory, enable an interpretation of this image, i.e. optical character recognition (OCR), for example, of the destination address and, when they are present on the postal article, barcode recognition. The recognition of these address or code data printed on the postal articles will allow, as is known, the creation of an address and postal article tracking database from these data and optionally from postal data input by the operator.

FIG. 6 illustrates a second embodiment of the movable optical reader assembly 26 in which a device allowing a force in a direction perpendicular to the direction of movement of the postal article to be applied to the sensor is added both to encourage the sensor to press on the postal article and also to ensure that the sensor returns quickly enough to the digitization position when postal articles pass at a high rate. Without this device, the sensor might, when a postal article passes, be projected upward and not have enough time to return to its position before the passage of the subsequent postal article. More particularly, such a device is formed by a damping device 60 or any other similar system responsible for pushing on the upper face of the support.

In addition, the sensor and its movable support may advantageously be coupled to a presser unit 62 positioned to the right of the sensor in the transport path of the postal articles and which presses on the lower face of the postal article in order to flatten its upper part against the sensor. This presser unit makes it possible to ensure that the postal article is uniformly in good contact with the sensor, thus avoiding the formation of waves on the surface of the postal article. It may be mounted on springs or any other similar system enabling the application of a compressive force to the postal article.

In this case, the damping system mounted on the sensor and springs situated on the presser enable the application of a compressive force on both sides of the postal article. Fine adjustment is necessary so as to find a preferred position that allows a digitization of optimum quality to be obtained. Compressive forces that are too low will not allow the postal article to be pressed enough and the digitization quality will be reduced. Compressive forces that are too high will cause the postal article to slow down, or even its blockage, and therefore digitization which will also be of poor quality.

In practice the inventor has been able to observe that the digitization is optimum for a force by the presser unit equal to or double the force applied to the support by the damping system.

It may be noted that, applied to the embodiment of FIG. 5A, the presser unit may also ensure the previously mentioned function of stopping the sensor in its rest position.

FIG. 7 illustrates, in perspective and as a cutaway, another embodiment of the movable optical reader assembly 26. Its CIS sensor 20A is again found mounted in the support in the form of a bridge with its upper wall 42 and its two longitudinal walls 32, 34, at the base of which the upstream 32A and downstream 34A deflectors are positioned. In this variant embodiment, the fixing and the swiveling of the support are ensured by a ball joint 64 fixed to the end of a single suspension arm 44 so as to allow, apart from vertical movement along the Z axis, rotations about the X and Y axes. Rotation about the Z axis is prevented by two stops 66 positioned at the two ends of the longitudinal wall 34 and intended to come into contact with a part of the structure of the machine. Of course, this configuration with a ball joint may also be implemented with the two suspension arms 44A, 44B (the two ball joints (one per arm) then advantageously replacing the play existing in the fixing of these two arms to the frame).

It will have been noted that although the movable optical reader assembly is mounted in an independent module in the exemplary embodiments described, it is of course obvious that, due to its particular compactness, it may be positioned in each of the modules of the postage meter system, i.e. just as well in its module 14 for selecting postal articles as in its module 16 for weighing postal articles, in its module 18 for printing these postal articles, or again in a folding and inserting module when it exists.

1. A digitization device (26) for a postage meter system for postal articles, comprising:
a contact image sensor (CIS 20A),
a support (30) on which said sensor is fixed, said support being arranged in a direction perpendicular to the advance of postal articles in said postage meter system and having a longitudinal axis Y and a transverse axis X, and
a movable fixing means (44A, 44B) for fixing said support onto a part of the structure of said postage meter system so as to allow a vertical movement of said support (translation along the Z axis) and its swiveling both about said longitudinal axis (rotation about the Y axis) and about said transverse axis (rotation about the X axis).

2. The digitization device as claimed in claim 1, wherein said movable fixing means comprises two suspension arms (44A, 44B) hinge-joined at one end to a common axle (54) joined to said part of the structure and at another end to a swivel pin (46A, 46B) fixed to said support, said swiveling about said transverse axis (rotation about the X axis) being ensured by a play in the connection of said first end.

3. The digitization device as claimed in claim 1, wherein said movable fixing means comprises a suspension arm (44) hinge-joined at one end to a common axle (54) joined to said part of the structure and at another end to a ball joint (64) joined to said support so as to enable, by means of said ball joint, said swiveling both about said transverse axis (rotation about the X axis) and about said longitudinal axis (rotation about the Y axis), and wherein stops (66) are furthermore provided in order to avoid any rotation during said vertical movement of said support.

4. The digitization device as claimed in claim 1, which furthermore comprises a damping device (60) in order to damp said vertical movement of said support.

5. The digitization device as claimed in claim 4, wherein said damping device consists of a simple spring.

6. The digitization device as claimed in claim 1, wherein said contact image sensor is formed of an integrated module comprising adjacent detection cells made of semiconductor, collimation optics and an illumination system.

7. The digitization device as claimed in claim 1, which is mounted in an independent subassembly of the postage meter system.

8. The digitization device as claimed in claim 1, which is mounted in one of the following subassemblies of the postage meter system: feeder, postal scales, postage meter, folder/inserter.

9. An element of a postage meter system comprising a digitization device as claimed in claim 1, in which said postal articles are applied to said digitization device by a presser unit (62) positioned to the right of said digitization system.

10. The element of a postage meter system as claimed in claim 9, wherein said presser unit is mounted on springs or any other similar system enabling the application of a compressive force to the postal article.
